(19) United States
(12) Patent Application Publication
(10) Pub. No.: US 2009/0171781 A1
(43) Pub. Date: Jul. 2, 2009

(54) LOCATION BASED ADVERTISEMENT DELIVERY TO PERVASIVE DEVICES

(76) Inventors: Sheila Elizabeth Allen, Peekskill, NY (US); Rick Allen Hamilton, II, Charlottesville, VA (US); Clifford Alan Pickover, Yorktown Heights, NY (US); James Wesley Seaman, Falls Church, VA (US)

Correspondence Address: DUKE W. YEE, YEE AND ASSOCIATES, P.C., P.O. BOX 802333, DALLAS, TX, 75380, US

(21) Appl. No.: 11/968,503

(22) Filed: Jan. 2, 2008

(51) Int. Cl. G06Q 30/00

(52) U.S. Cl. 705/14

(57) ABSTRACT

A computer implemented method, computer program product, and data processing system display advertisements on a pervasive device. A wireless signal for an advertisement is received by the pervasive device. The advertisement includes advertisement information. Responsive to receiving the wireless signal, the advertisement information is compared to user preferences to determine whether the advertisement information matches the user preferences. In the event that the advertisement information matches at least one of the user preferences, the advertisement is displayed on the pervasive device.

### BACKGROUND OF THE INVENTION

1. Field of the Invention

The present invention relates generally to an improved data processing systems. More specifically, the present invention relates to computer implemented method, apparatus, and computer program product for providing location based advertisements to users proximate to a merchant.

2. Description of the Related Art

Advertising reduced prices for products and services is an effective method for enticing consumers to visit particular stores or to purchase specific products and services. While many methods exist for advertising and targeted advertising, these known methods generally provide advertising materials based on what the business wants to sell as opposed to what the consumer is interested in purchasing. As a result, many printed and electronic advertisements are discarded by the consumer without ever reading them. Furthermore, these methods do not provide a way to target potential customers that may be temporarily located close to the business.

For example, a consumer might be walking through a shopping mall and pass by various stores that sell shoes. While the consumer may be looking for shoes, the consumer has no way of knowing that the various stores are currently running a sale on a type of shoe that the consumer is interested in purchasing. Furthermore, the various stores have no way of knowing that this particular customer is interested in purchasing shoes. The consumer must look in a number of various stores to find the desired shoes. Likewise, the store must market the shoes to a much wider audience in order to reach those relatively few consumers that may be interested in the on-sale shoes.

### SUMMARY OF THE INVENTION

A computer implemented method, computer program product, and data processing system are provided for displaying advertisements on a pervasive device. A wireless signal for an advertisement is received by the pervasive device. The advertisement includes advertisement information. Responsive to receiving the wireless signal, the advertisement information is compared to user preferences to determine whether the advertisement information matches the user preferences. In the event that the advertisement information matches at least one of the user preferences, the advertisement is displayed on the pervasive device.

### BRIEF DESCRIPTION OF THE DRAWINGS

The novel features believed characteristic of the invention are set forth in the appended claims. The invention itself, however, as well as a illustrative mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which an illustrative embodiment may be implemented;

FIG. 2 is a block diagram of a data processing system in which an illustrative embodiment may be implemented;

FIG. 3 is a diagram depicting a flow of data through the various components of the system according to an illustrative embodiment;

FIG. 4 is a diagram depicting the flow of data through components of a data processing system according to an illustrative embodiment;

FIG. 5 is a block diagram of a software system for entering user preferences into a pervasive device in accordance with an illustrative embodiment;

FIG. 6 is a block diagram of the processing steps in a software system for displaying local advertisements to a user based on user preferences according to an illustrative embodiment;

FIG. 7 is a block diagram of the processing steps in a software system for transmitting local advertisements to a pervasive device according to an illustrative embodiment; and

FIG. 8 is a block diagram illustrating the entering user preferences into an operating system of a pervasive device according to an illustrative embodiment.

### DETAILED DESCRIPTION OF THE PREFERRED EMBODIMENT

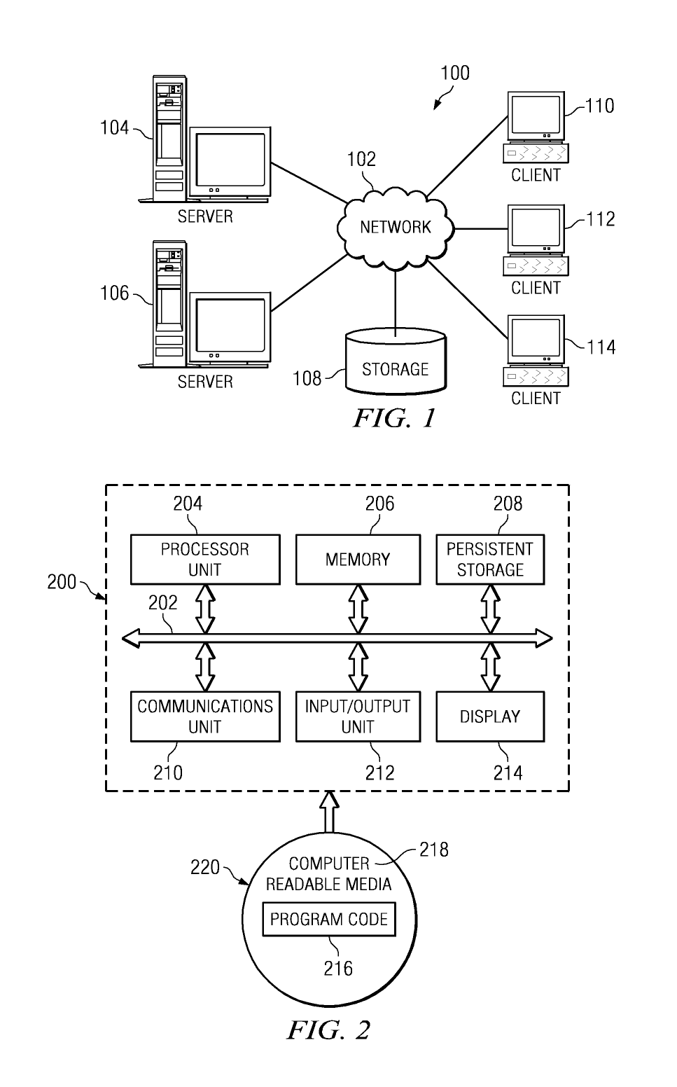

With reference now to the figures and in particular with reference to FIGS. 1-2, exemplary diagrams of data processing environments are provided in which an illustrative embodiment may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which an illustrative embodiment may be implemented. Network data processing system 100 is a network of computers in which the an illustrative embodiment may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Server 104 can generate a wireless signal for an advertisement that is received by a pervasive device, which can be clients 110, 112, and 114. The advertisement includes advertisement information. Responsive to receiving the wireless signal, the advertisement information is compared to user preferences to determine whether the advertisement information matches the user preferences. In the event that the advertisement information matches at least one of the user preferences, the advertisement is displayed on the pervasive device.

Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which an illustrative embodiment may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206, in these examples, may be, for example, a random access memory. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as, program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive or a flash memory that is connected to data processing system 200.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

The different components illustrated for data processing system 200 are not meant to provide architectural limitations to the manner in which different embodiments may be implemented. The different an illustrative embodiment may be implemented in a data processing system including components in addition to or in place of those illustrated for data processing system 200. Other components shown in FIG. 2 can be varied from the illustrative examples shown.

For example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache, such as found in an interface and memory controller hub that may be present in communications fabric 202.

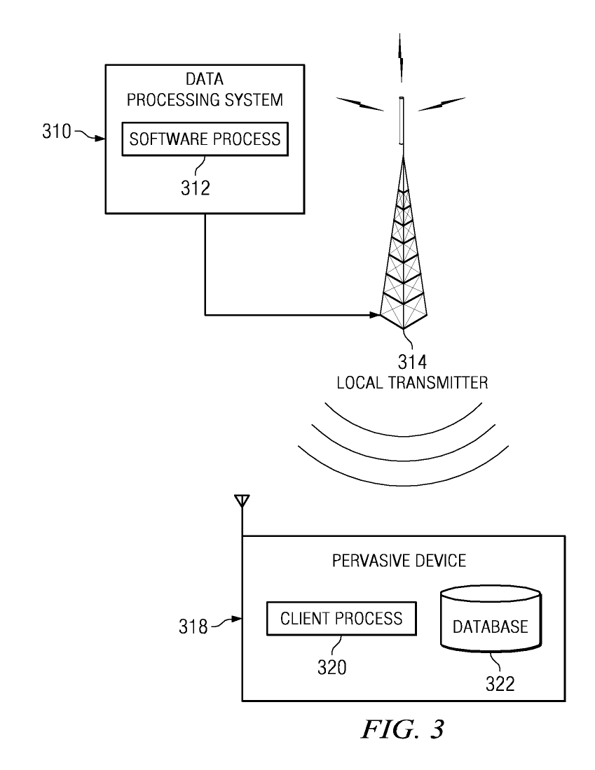

Referring now to FIG. 3, a diagram depicting a flow of data through the various components of the system is shown according to an illustrative embodiment.

Data processing system 310 executes software process 312. Data processing system can be data processing system 200 of FIG. 2. Software process 312 is a software process receiving and forwarding advertisement information. Advertisement information is the details of an offer from a merchant, such as are generally contained in an advertisement. Advertisement information can be stored in a local database and transmitted to consumers using local transmitter 314. Advertisement information may include a designation of one or more categories within a categorized index of advertised goods, defining a broad classification of the advertised good. For example, the categorized index might include broad categories such as, without limitation, shoes, clothing, furniture, home decor, food, and other suitable items. Advertisement information can also include offer details of the advertisement, including a merchant's name, a price of an item, a discounted price or discounted percentage, etc. Advertisement information can also include location information specifying a geographical area in which an advertisement should be transmitted.

Software process 312 utilizes a pushed media to forward advertisement information to local transmitter 314. A pushed media is a style of communication protocol where the request for a given transaction originates with the server publisher, not the receiver client. A pushed media signal is communication utilizing the pushed media style of communication. Because software process 312 utilizes a pushed media, software process 312 initiates the transfer of advertisement information rather than local transmitter 314.

Push transactions are often based on information preferences expressed in advance—such as a “subscription” model. By registering a specific address, local transmitter 314 might “subscribe” to various information “channels” from different merchants that are pushed to local transmitter 314 by various data processing systems of those merchants running software process 314. Whenever new content was available on one of those channels, software process 314 would “push” that information out to local transmitter 314. Thus, the pushed media can be a list of aggregated advertisements from different merchants. Aggregated advertisements are a list of different advertisement information. In one illustrative embodiment, a push transaction can utilize a push instant message access protocol, a push e-mail protocol, or a push access protocol. Software process 312 may act as control software for local transmitter 314.

In one illustrative embodiment, a service provider, could make use of a standard format (e.g. XML) supplied from a merchant to the service provider. This could be implanted via a Really Simple Syndication (RSS) feed from merchants offering sales. The merchants need not provide a continuous stream of information to the service provider. Rather, the merchant can simply update an extensible markup language file at the really simple syndication location. The service provider would then subscribe to various Really Simple Syndication (RSS) store feeds. The service provider may charge a fee to the stores to be included in this service. Extensible markup language schema may be used for universal product codes, item name, item description, original price, sale price, rebate, or any other information that should be included in the advertisement information.

Local transmitter 314 is any transmitter capable of transmitting wireless signals to pervasive device 318. Pervasive device 318 is a mobile device capable of receiving wireless transmissions 316 from local transmitter 314. Pervasive device can be, for example, without limitation, a cellular phone, a personal digital assistant, a mobile email device, a laptop computer, a digital media player, or any other device configured to receive wireless transmissions 316.

In one illustrative embodiment, the location of pervasive device 318 is proximately determined. The location of pervasive device 318 can be proximately determined by global positioning signals, triangulation location, or other known location positioning methods. Local transmitter could then transmit to pervasive device 318 advertisement information using cellular, radio, or other longer range wireless frequencies.

In another illustrative embodiment, local transmitter 314 persistently transmits advertisement information utilizing a short range wireless protocol. Local transmitter 314 can utilize any short-range wireless protocol, including, but not limited to, wireless universal serial bus, active radio frequency identification, dedicated short range communications, Bluetooth, wireless fidelity, near field communications, and Zigbee. When local transmitter 314 persistently transmits advertisement information, pervasive device 318 is informed of a local advertisement by entering an area in which the short range signal can be received by pervasive device 318.

Pervasive device 318 runs client process 320. Client process 320 is a software process capable of receiving and filtering advertisement information based on stored user preferences. Pervasive contains database 322. Database 322 stores user preferences about the type of advertisement information that should be displayed. User preferences may include items or categories of goods in which the user is interested. User preferences may exclude items or categories of goods in which the user is uninterested.

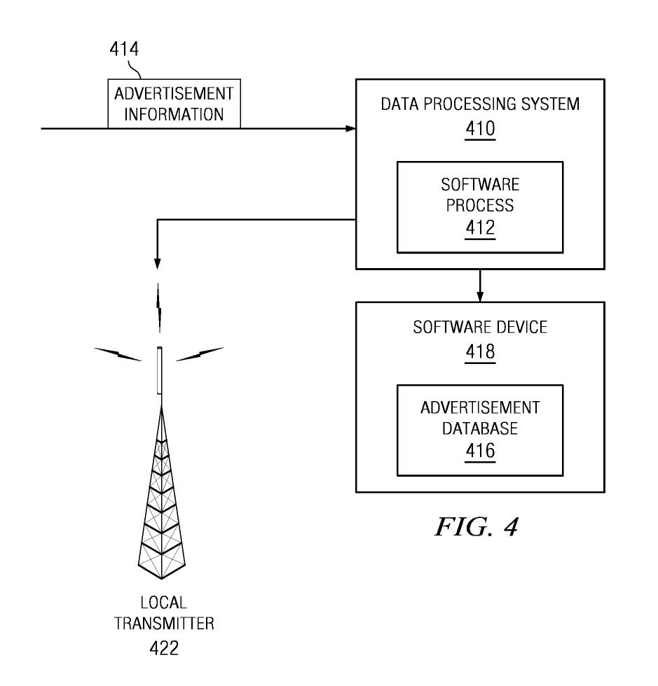

Referring now to FIG. 4, a diagram depicting the flow of data through components of a data processing system is shown according to illustrative embodiments. Data processing system 410 can be data processing system 310 of FIG. 3.

Data processing system 410 executes software process 412. Software process 412 can be software process 312 of FIG. 3.

Advertisement information 414 is entered into software process 412, and stored in advertisement database 416 on storage device 418. Advertisement database 416 is a database storing advertisement information 414 for at least one merchant. Advertisement information 414 may include a designation of one or more categories within a categorized index of advertised goods, defining a broad classification of the advertised good. For example, the categorized index might include broad categories, such as, without limitation, shoes, clothing, furniture, home decor, food, etc. Advertisement information can also include offer details of the advertisement, including a merchant's name, a price of an item, a discounted price or discounted percentage, etc. Advertisement information may also include location information specifying a geographical area in which an advertisement should be transmitted.

Software process 412 forwards advertisement information 414 to local transmitter 422. Software process 412 utilizes a pushed media to forward advertisement information 414 to local transmitter 422. A pushed media is a style of communication protocol where the request for a given transaction originates with the server publisher, not the receiver client. That is, software process 412 initiates the transfer of advertisement information 414 rather than local transmitter 422.

Push transactions are often based on information preferences expressed in advance—such as a “subscription” model. By registering a specific address, local transmitter 422 might “subscribe” to various information “channels” from different merchants that are pushed to local transmitter 422 by various data processing systems of those merchants running software process 412. Whenever new content was available on one of those channels, software process 412 would “push” that information out to local transmitter 422. In one illustrative embodiment, a push transaction can utilize a push instant message access protocol, a push e-mail protocol, or a push access protocol.

Local transmitter 422 can be local transmitter 314 of FIG. 3. Responsive to receiving advertisement information 414, local transmitter 422 wirelessly transmits advertisement information 414 throughout an area proximate to local transmitter 422. The area proximate to local transmitter 422 can vary with signal strength of the transmission, and the area in which a local merchant may want to broadcast advertisement information 414.

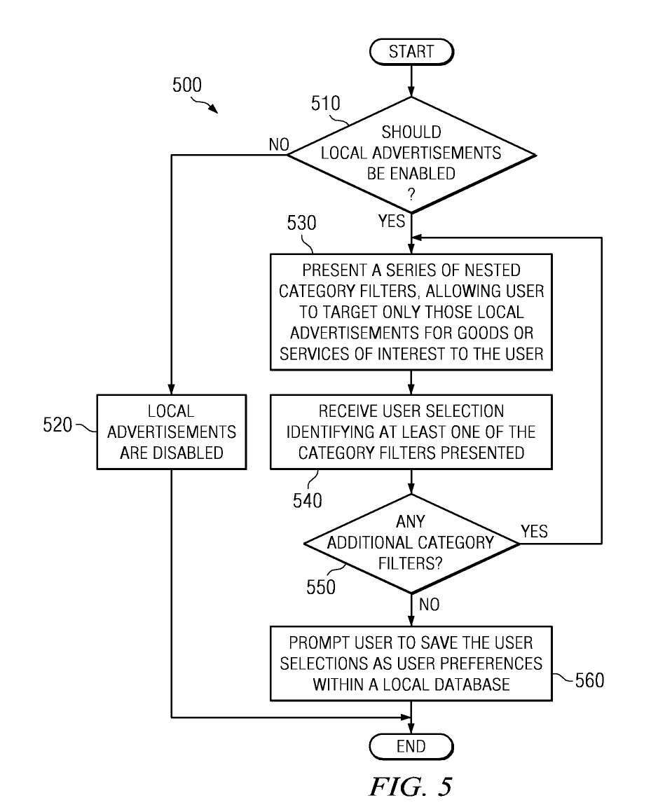

Referring now to FIG. 5, block diagram of a software system for entering user preferences into a pervasive device is shown according to an illustrative embodiment. Process 500 is a software process capable of receiving and filtering advertisement information based on stored user preferences, such as client process 320 of FIG. 3.

Process 500 begins by receiving a user selection of whether local advertisements should be enabled (step 510). Responsive to a user selection to disable local advertisements (“no” at step 510), local advertisements are disabled (step 520), with the process terminating thereafter. When the user has made a selection to disable local advertisements, no local advertisements will be displayed to the user.

Returning to block 510, responsive to a user selection to enable local advertisements (“yes” at step 510), process 500 presents to the user a series of nested category filters, allowing the user to target only those local advertisements for goods or services in which the user is interested (step 530).

Responsive to presenting to the user a series of nested filters, a user selection is received identifying at least one of the category filters presented (step 540). If the user selection is received identifying at least one of the category filters which contains additional nested category filters, process 500 returns to step 510 to receive additional user selections.

Next, Process 500 identifies if there are any additional category filters (step 550). If an additional nested category filter is identified within the previous filter (“yes” at step 550), process 500 returns to step 530 to present to the user a series of nested category filters, allowing the user to target only those local advertisements for goods or services in which the user is interested.

Responsive to not identifying an additional nested category filter within the previous filter (“no” at step 550), when the final user selection has been received, process 500 prompts the user to save the user selections as user preferences within a local database (step 560), with the process terminating thereafter. Responsive to enabling local advertisements, process 500 will now display local advertisements to the user. However, process 500 will only display those advertisements wherein the advertisement information corresponds to the user preferences.

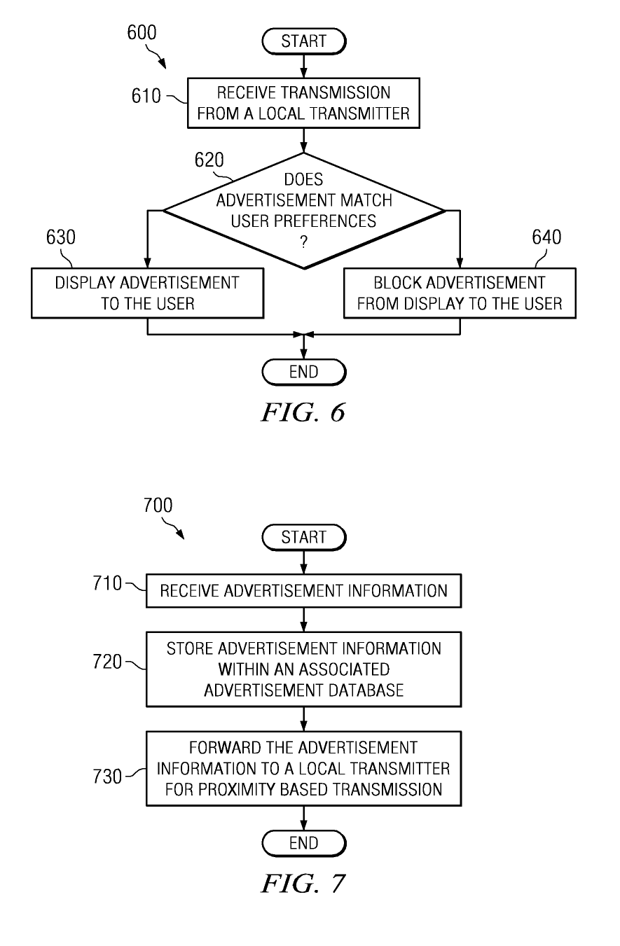

Referring now to FIG. 6, a block diagram of the processing steps in a software system for displaying local advertisements to a user based on user preferences is shown according to an illustrative embodiment. Process 600 is a software process capable of receiving and filtering advertisement information based on stored user preferences, such as client process 320 of FIG. 3.

Process 600 begins by receiving a transmission from a local transmitter (step 610). A Local transmitter is a transmission device capable of transmitting short range wireless signals, such as local transmitter 314 of FIG. 3. The transmission contains local advertisements having advertisement information. Advertisement information includes a designation of one or more categories within a categorized index of advertised goods. The categorized index corresponds to user preferences stored within a local database of the pervasive device.

Process 600 then determines whether the advertisement information matches the user preferences stored within the local database (step 620). The advertisement information matches the user preferences stored within the local database when the advertisement information and the user preferences both reference an identical category of advertised goods. Responsive to determining that the advertisement information matches the user preferences stored within the local database (“yes” at step 620), process 600 displays the local advertisement to the user (step 630), with the process terminating thereafter. The user has included the classification of goods to which the advertisement information belongs among the user preferences, and has therefore chosen to display those related advertisements. Therefore, the local advertisement is displayed to the user.

Returning again to block 620, responsive to determining that the advertisement information does not match the user preferences stored within the local database (“no” at step 620), process 600 blocks the local advertisement from display to the user (step 640), with the process terminating thereafter. The user has excluded the classification of goods to which the advertisement information belongs from the user preferences, and has therefore chosen not to display those related advertisements. Therefore, the local advertisement is not displayed to the user.

Referring now to FIG. 7, a block diagram of the processing steps in a software system for transmitting local advertisements to a pervasive device is shown according to an illustrative embodiment. Process 700 is a software process, such as software process 312 of FIG. 3, executed on a data processing system, such as data processing system 310 of FIG. 3.

Process 700 begins by receiving advertisement information (step 710). Advertisement information may include a designation of one or more categories within a categorized index of advertised goods, defining a broad classification of the advertised good. For example, the categorized index might include broad categories, such as, without limitation, shoes, clothing, furniture, home decor, food, etc. Advertisement information may also include offer details of the advertisement, including a merchant's name, a price of an item, a discounted price or discounted percentage. Advertisement information may also include location information specifying a geographical area in which an advertisement should be transmitted. Advertisement information can be input into process 700 by a merchant, system administrator, or other person with authorization to update the associated advertisement database. Process 700 then stores advertisement information within an associated advertisement database (step 720).

Process 700 next forwards the advertisement information to a local transmitter, such as local transmitter 314 of FIG. 3, for proximity based transmission (step 730), with the process terminating thereafter. In one illustrative embodiment, the location of pervasive device 318 is proximately determined. The location of the pervasive device can be proximately determined by global positioning signals, triangulation location, or other known location positioning methods. Local transmitter could then transmit to the pervasive device advertisement information using cellular, radio, or other longer range wireless frequencies. In another illustrative embodiment, the local transmitter persistently transmits advertisement information utilizing a short range wireless protocol. When the local transmitter persistently transmits advertisement information, the pervasive device is informed of a local advertisement by entering an area in which the short range signal can be received by the pervasive device. The local transmitter can utilize any short-range wireless protocol, including, but not limited to, wireless universal serial bus, active radio frequency identification, dedicated short range communications, Bluetooth, wireless fidelity, near field communications, and Zigbee.

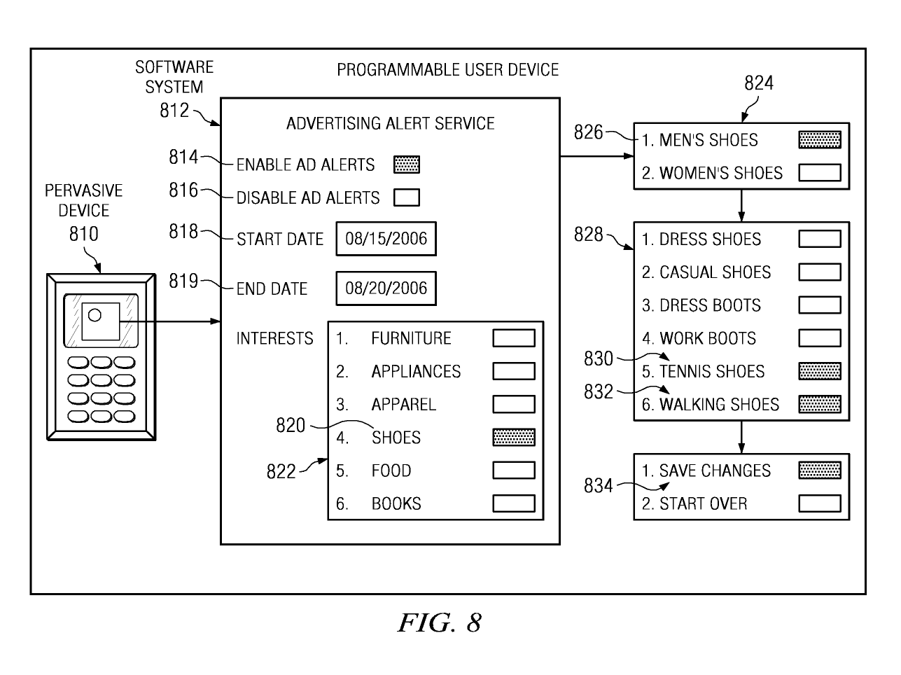

Referring now to FIG. 8, a block diagram illustrating the entering user preferences into an operating system of a pervasive device is shown according to an illustrative embodiment. Pervasive device 810 is a mobile device capable of receiving wireless transmissions, such as pervasive device 318 of FIG. 3. Software system 812 is a software process capable of receiving and filtering advertisement information based on stored user preferences, such as client process 320 of FIG. 3.

A user selection is made between “enable ad alerts” 814 and “disable ad alerts” 816. In the illustrative example shown herein, the user has selected “enable ad alerts” 814, thereby causing software system 812 to present to the user a series of nested category filters, allowing the user to target only those local advertisements for good or services in which the user is interested. Had the user instead selected “disable ad alerts” 816, the series of nested category filters would not be presented. The user would have made a selection to disable local advertisements, so that no local advertisements would be displayed to the user.

When the user has chooses “enable ad alerts” 814, the user can also choose to filter the received local advertisements based on the age of the advertisement. When a merchant enters advertisement information for wireless transmission, the advertisement information may include an offer period, such as a starting date, a duration, and an ending date. A user can choose to filter local advertisements based on the offer period by entering values at start date 818 and end date 819.

The user is then presented with a series of nested category filters, allowing the user to target only those local advertisements for goods or services in which the user is interested. Responsive to presenting to the user a series of nested filters, a user selection is received identifying at least one of the category filters presented. If the user selection is received identifying at least one of the category filters which contains additional nested category filters, software system 812 will prompt the user for entry of additional user selections.

Software system 812 first presents the user with a series of nested category filters including the category “shoes” 820 within the root category 822. The category “shoes” 820 is indicated as being selected by the user. Responsive to the user selecting the category “shoes” 820, the user is then presented with a first nested sub-filter 824, including the category “Men's shoes” 826. Responsive to the user selecting the category “Men's shoes” 826, the user is then presented with a second nested sub-filter 828, including the categories “Tennis shoes” 830, and “Walking shoes” 832. The categories “Tennis shoes” 830, and “Walking shoes” 832 are indicated as being selected by the user. No additional sub-filters stem from either of the categories “Tennis shoes” 830, or “Walking shoes” 832.

Having received the final user selection, software system 812 prompts the user to save the user selections as user preferences within a local database. This is displayed as “Save changes” 834. Responsive to receiving local advertisements, software system 812 will now display local advertisements to the user. However, software system 812 will only display those advertisements wherein the advertisement information corresponds to the user preferences. Therefore, advertisements having advertisement information corresponding to the categories “Tennis shoes” 830, or “Walking shoes” 832 will be displayed to the user.

The illustrative embodiments therefore describe a computer implemented method, computer program product, and data processing system for displaying advertisements on a pervasive device. A wireless signal for an advertisement is received by the pervasive device. The advertisement includes advertisement information. Responsive to receiving the wireless signal, the advertisement information is compared to user preferences to determine whether the advertisement information matches the user preferences. In the event that the advertisement information matches at least one of the user preferences, the advertisement is displayed on the pervasive device.

The invention can take the form of an entirely hardware embodiment, an entirely software embodiment or an embodiment containing both hardware and software elements. In a illustrative embodiment, the invention is implemented in software, which includes, but is not limited to, firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including, but not limited to, keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for displaying advertisements on a pervasive device, the method comprising:
receiving a wireless signal for an advertisement on the pervasive device, the wireless signal comprising a list of aggregated advertisements from a pushed media signal, the advertisement including advertisement information;
responsive to receiving the wireless signal, determining, by the pervasive device, whether the advertisement information matches at least one user preference; and
responsive to a determination that the advertisement information matches the at least one user preference, displaying the advertisement on the pervasive device.

2. The computer implemented method of claim 1, wherein the wireless signal is a short-range wireless protocol selected from the group consisting of wireless universal serial bus, active radio frequency identification, dedicated short range communications, Bluetooth, wireless-fidelity, near field communication, and Zigbee.

3. The computer implemented method of claim 1, wherein the wireless signal is a longer range wireless frequency selected from the group consisting of cellular frequencies and radio frequencies.

4. The computer implemented method of claim 1, wherein the advertisement information includes at least one of a designation of one or more categories within a categorized index, offer details of the advertisement, and location information.

5. The computer implemented method of claim 1, further comprising:
responsive to an absence of a determination that the advertisement information matches the at least one user preference, blocking the advertisement from being displayed on the pervasive device.

6. The computer implemented method of claim 1, further comprising:
identifying whether display of the advertisement has been disabled; and
responsive to identifying that display of the advertisement has been disabled, blocking the advertisement from being displayed on the pervasive device.

7. The computer implemented method of claim 1, wherein the at least one user preference is selected from a series of nested category filters.

8. A computer program product comprising:
a computer readable medium having computer usable program code for displaying advertisements on a pervasive device, the computer program product comprising:
computer usable program code for receiving a wireless signal for an advertisement on the pervasive device, the advertisement including advertisement information;
computer usable program code, responsive to receiving the wireless signal, for identifying whether the advertisement information matches at least one user preference; and
computer usable program code responsive to identifying that the advertisement information matches the at least one user preference, for displaying the advertisement on the pervasive device.

9. The computer program product of claim 8, wherein the computer usable program code for receiving the wireless signal is computer usable program code for receiving a short-range wireless protocol selected from the group consisting of wireless universal serial bus, active radio frequency identification, dedicated short range communications, Bluetooth, wireless-fidelity, near field communication, and Zigbee.

10. The computer program product of claim 8, wherein the computer usable program code for receiving a wireless signal is computer usable program code for receiving a longer range wireless frequency selected from the group consisting of cellular frequencies and radio frequencies.

11. The computer program product of claim 8, wherein the advertisement information includes at least one of a designation of one or more categories within a categorized index, offer details of the advertisement, and location information.

12. The computer program product of claim 8, further comprising:
computer usable program code, responsive to an absence of a determination that the advertisement information matches the at least one user preference, and for blocking the advertisement from being displayed on the pervasive device.

13. The computer program product of claim 8, further comprising:
computer usable program code for identifying whether display of the advertisement has been disabled; and
computer usable program code, responsive to identifying that display of the advertisement has been disabled, and for blocking the advertisement from being displayed on the pervasive device.

14. The computer program product of claim 8, wherein the at least one user preference is selected from a series of nested category filters.

15. A computer implemented method for transmitting advertisements to a pervasive device, the method comprising:
receiving a pushed media signal from a merchant for an advertisement, the advertisement including advertisement information;
responsive to receiving the pushed media signal for an advertisement, updating a local database to include the advertisement information;
broadcasting the advertisement information.

16. The computer implemented method of claim 15, the method further comprising:
receiving the pushed media signal from the merchant in the form of a really simple syndication feed.

17. The computer implemented method of claim 15, the method further comprising:
receiving the pushed media signal from the merchant for the advertisement, wherein the advertisement information comprises at least one of a designation of one or more categories within a categorized index of advertised goods, a merchant's name, a price, a discounted price or discounted percentage, and a geographical area in which the advertisement should be transmitted.

18. The computer implemented method of claim 15, further comprising:
broadcasting the advertisement information using a short-range wireless protocol, selected from the group comprising wireless universal serial bus, active radio frequency identification, dedicated short range communications, Bluetooth, wireless fidelity, near field communications, and Zigbee.

19. The computer implemented method of claim 15, further comprising:
receiving a pushed media signal from a merchant for an advertisement, wherein the pushed media signal is selected from the group comprising a push instant message access protocol, a push e-mail protocol, or a push access protocol.

20. The computer implemented method of claim 17, further comprising the advertisement information comprising the designation of one or more categories within a categorized index of advertised goods, wherein the categorized index of advertised goods comprises nested category filters.
